(19) United States
(12) Patent Application Publication
(10) Pub. No.: US 2026/0296738 A1
(43) Pub. Date: Oct. 1, 2026

(54) LID ADAPTER FOR TRAYS FOR FOOD PRODUCTS, RELATED SYSTEMS AND METHODS

(71) Applicant: Graphic Packaging International, LLC, Atlanta, GA (US)

(72) Inventor: Jeffrey D. Smith, Solon, OH (US)

(21) Appl. No.: 19/631,680

(22) Filed: Mar. 27, 2026

Related U.S. Application Data
(60) Provisional application No. 63/781,530, filed on Apr. 1, 2025.

(51) Int. Cl. B65D 43/16; B31B 50/00

(52) U.S. Cl. CPC B65D 43/169; B31B 50/004

(57) ABSTRACT

A lid adapter for a tray for holding one or more products may comprise a base panel having a base opening. The base panel may be arranged for attachment to a portion of the tray such that the base opening provides access to an interior of the tray. The lid adapter may comprise a lid panel foldably connected to the base panel. The lid panel may include a lid opening. The lid panel may be repositionable between an open position and a closed position when the base panel is attached to the portion of the tray.

### CROSS-REFERENCE TO RELATED APPLICATION

The present application claims priority to U.S. Provisional Patent Application No. 63/781,530 filed on Apr. 1, 2025.

### INCORPORATION BY REFERENCE

The disclosure of U.S. Provisional Patent Application No. 63/781,530, filed on Apr. 1, 2025, is hereby incorporated by reference for all purposes as if presented herein in its entirety.

### TECHNICAL FIELD

The present disclosure relates to trays for holding food products. In some embodiments, the present disclosure relates to lid adapters for trays for food products.

### BACKGROUND

Conventional food packaging systems may utilize separate trays and lids that can be misplaced, improperly fitted, or may not reclose effectively after opening. Press-formed or molded trays are often optimized for forming strength and nesting, but integrating a robust hinge and lid structure into such trays can require costly tooling changes and may reduce supplier flexibility. Existing approaches may include snap-on plastic lids sized for specific tray geometries, clamshell containers with integrated lids, or heat-sealed film lidding over tray rims, but these solutions may suffer from poor closure retention that can cause spills and contamination, limited visibility of contents without opening, and difficulties in waste-stream segregation when mixed materials are permanently bonded together. Additionally, conventional systems may lack the ability to provide both viewing access and barrier protection while maintaining a recloseable configuration suitable for stacking and transport.

### SUMMARY OF THE DISCLOSURE

According to one aspect, a lid adapter for a tray for holding one or more products may comprise a base panel having a base opening, the base panel arranged for attachment to a portion of the tray such that the base opening provides access to an interior of the tray. The lid adapter may further comprise a lid panel foldably connected to the base panel, the lid panel including a lid opening, wherein the lid panel may be repositionable between an open position and a closed position when the base panel is attached to the portion of the tray.

In some embodiments, the lid adapter may further comprise a front end flap foldably attached to the lid panel by a fold line, wherein the fold line may be interrupted by a locking cut. The base panel may include at least one locking tab and wherein, in the closed position, the locking tab may be at least partially received through the locking cut. The locking tab may be at least partially defined by a recessed portion of a free edge of the base panel. The lid adapter may further comprise at least one side end flap foldably connected to the lid panel. The at least one side end flap may include a base portion and a corner portion foldably connected to the base portion. The lid adapter may further comprise a film at least partially extending across the lid opening.

According to another aspect, a blank for forming a lid adapter for a tray for holding one or more products may comprise a base panel having a base opening, the base panel arranged for attachment to a portion of the tray such that the base opening provides access to an interior of the tray when the blank is erected. The blank may further comprise a lid panel foldably connected to the base panel, the lid panel including a lid opening, wherein the lid panel may be arranged to be repositionable between an open position and a closed position when the base panel is attached to the portion of the tray.

In some embodiments, the blank may further comprise a front end flap foldably attached to the lid panel by a fold line, wherein the fold line may be interrupted by a locking cut. The base panel may include at least one locking tab and wherein, in the closed position, the locking tab may be arranged to be at least partially received through the locking cut when the blank is erected. The locking tab may be at least partially defined by a recessed portion of a free edge of the base panel. The blank may further comprise at least one side end flap foldably connected to the lid panel. The at least one side end flap may include a base portion and a corner portion foldably connected to the base portion. The blank may further comprise a film at least partially extending across the lid opening.

According to another aspect, a method for forming a lid adapter for a tray for holding one or more products may comprise providing a base panel having a base opening, attaching the base panel to a portion of the tray such that the base opening provides access to an interior of the tray, and positioning a lid panel that is foldably connected to the base panel, the lid panel including a lid opening, wherein the lid panel may be repositionable between an open position and a closed position when the base panel is attached to the portion of the tray. The method may further comprise providing a front end flap foldably attached to the lid panel by a fold line, wherein the fold line may be interrupted by a locking cut. The base panel may include at least one locking tab and wherein the method may further comprise, in the closed position, at least partially receiving the locking tab through the locking cut. The locking tab may be at least partially defined by a recessed portion of a free edge of the base panel. The method may further comprise providing at least one side end flap foldably connected to the lid panel. The at least one side end flap may include a base portion and a corner portion foldably connected to the base portion. The method may further comprise providing a film at least partially extending across the lid opening.

According to another aspect, a system may comprise a tray for holding one or more products and a lid adapter. The lid adapter may comprise a base panel having a base opening, the base panel attached to a portion of the tray such that the base opening provides access to an interior of the tray, and a lid panel foldably connected to the base panel, the lid panel including a lid opening, wherein the lid panel may be repositionable between an open position and a closed position when the base panel is attached to the portion of the tray.

In some embodiments, the lid adapter may further comprise a front end flap foldably attached to the lid panel by a fold line, wherein the fold line may be interrupted by a locking cut. The base panel may include at least one locking tab and wherein, in the closed position, the locking tab may be at least partially received through the locking cut. The locking tab may be at least partially defined by a recessed portion of a free edge of the base panel. The lid adapter may further comprise at least one side end flap foldably connected to the lid panel. The at least one side end flap may include a base portion and a corner portion foldably connected to the base portion. The lid adapter may further comprise a film at least partially extending across the lid opening.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for forming a lid adapter and system, according to an embodiment of the disclosure.

FIG. 2 is a top perspective view of a lid adapter shown in an open configuration and formed from the blank of FIG. 1, according to an embodiment of the disclosure.

FIG. 3 is a bottom perspective view of the lid adapter of FIG. 2 shown in an open configuration, according to an embodiment of the disclosure.

FIG. 4 is a top perspective view of the lid adapter of FIG. 2 shown in an open configuration, according to an embodiment of the disclosure.

FIG. 5 is a top perspective view of the lid adapter of FIG. 2 shown in a closed configuration, according to an embodiment of the disclosure.

Corresponding parts are designated by corresponding reference numbers throughout the drawings.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to lid adapters for trays for holding one or more products. More specifically, techniques disclosed herein relate to lid adapters including a base panel and a lid panel foldably connected to the base panel that may be attached to a tray to provide the tray with a hinged, openable, and recloseable lid configuration having both a locking mechanism and a film spanning a lid opening. Various embodiments may be described herein, including lid adapters, blanks for forming such lid adapters, systems including a lid adapter and a tray, methods of forming lid adapters, and the like.

In order to better appreciate the features and aspects of the present disclosure, further context for the disclosure may be provided in the following section by discussing one particular implementation of a lid adapter that may be attached to a tray to form a system according to embodiments of the disclosure. These embodiments may be for explanatory purposes only and other embodiments may be employed in other packaging applications. For example, embodiments of the disclosure may be used with any tray or similar structure that receives, holds, stores, transports, displays, or serves one or more products. In some instances, embodiments of the disclosure may be particularly well suited for use with trays for food products, such as press-formed trays used in quick-service restaurant, food-service, catering, take-out, or retail food packaging environments, because of their potentially compact form factor and their compatibility with a lid adapter that may be attached to a tray without requiring modification of the tray's own manufacturing process.

The present disclosure relates to a lid adapter for a tray for holding one or more products, a blank for forming such a lid adapter, and a method of forming the lid adapter from the blank. In general terms, the lid adapter may be thought of as an add-on structure that may be attached to a tray, such as a press-formed tray, to provide the tray with a hinged, openable, and recloseable lid configuration. The lid adapter may be formed from a flat sheet of paperboard or similar material, referred to as a blank, which may be pre-cut and pre-scored so that it may be folded into a three-dimensional lid adapter structure. The blank may include a base panel and a lid panel foldably connected to the base panel, such that when the base panel may be attached to a portion of the tray, the lid panel may be repositioned between an open position and a closed position relative to the tray.

The lid adapter may include a film at least partially covering a lid opening formed in the lid panel. The film may be at least partially transparent, such that the contents of the tray may be visualized through the film when the lid panel may be in the closed position. The film may also function as at least a partial barrier against moisture, heat, debris, and pests between an exterior environment and the interior of the tray. In this regard, the lid adapter may provide a means by which one or more food products held in the tray may be maintained, stored, transported, displayed, or served in a protected condition, while also allowing the contents of the tray to be viewed without opening the lid.

The lid adapter may further include a locking mechanism comprising one or more locking tabs formed in the base panel and one or more locking cuts formed in a front end flap foldably connected to the lid panel. When the lid panel may be moved to the closed position, the locking tabs may be at least partially received through the locking cuts to maintain the closed configuration. The locking tabs may be withdrawn from the locking cuts to return the lid panel to the open position, providing repeated access to the interior of the tray. The lid adapter and the tray may be separable from one another at the end of use, such that the lid adapter and the tray may be disposed of in separate waste streams appropriate to their respective materials.

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

Trays and lid adapters according to the present disclosure can accommodate articles of numerous different shapes. For the purpose of illustration and not for the purpose of limiting the scope of the disclosure, the following detailed description describes articles such as food products at least partially disposed upon or within the tray/lid adapter embodiments.

The articles can include food products such as prepared food products, fresh food products, food products delivered at a quick service restaurant. Accordingly, such food products could include meat products (e.g., ground meat, sliced meat, diced meat, sausage, cured meat, etc.), fish products (such as sushi or other fish rolls), take-out products, meal leftovers, and the like, or any combination thereof. Examples of such products can include pastries (e.g., filled or frosted pastries), breads, fruit bars, French toast sticks, fish, chicken (such as chicken nuggets, chicken strips, chicken fingers, etc.), popcorn, peanuts, candy, French fries (such as waffle fries, steak fries, shoestring fries, curly fries, etc.), sandwiches, pizza, calzone, turnover, tacos, burritos, enchiladas, chalupas, chimichangas, churros, gorditas, huaraches, quesadillas, tamales, or any other food product that may be provided for consumption by a consumer. Such food products could be provided hot, e.g., at freshly cooked/heated temperatures and/or to taste, though could be served at lower temperatures without departing from the disclosure. In this specification, the terms “inner,” “interior,” “outer,” “exterior,” “lower,” “bottom,” “upper,” and “top” indicate orientations determined in relation to fully erected and upright containers.

As described herein, trays and lid adapters may be formed by multiple overlapping panels, end flaps, and/or other portions of blanks. Such panels, end flaps, and/or other portions of the blanks can be designated in relative terms to one another, e.g., “first”, “second”, “third”, etc., in sequential or non-sequential reference, without departing from the disclosure.

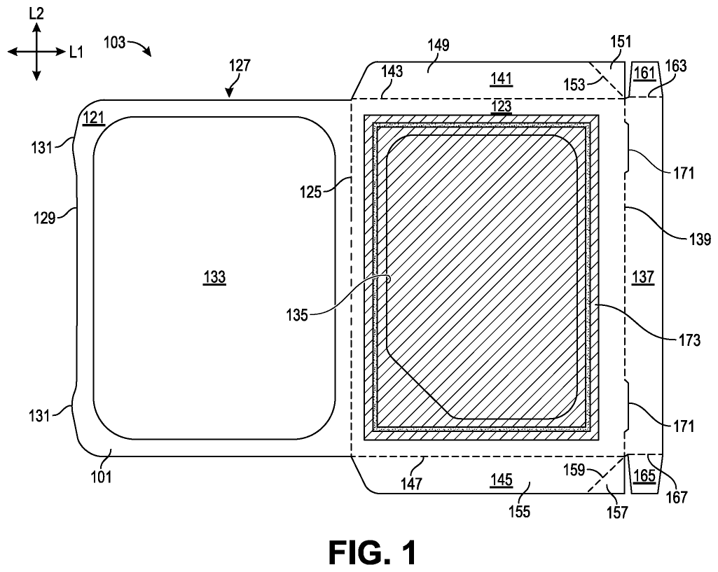

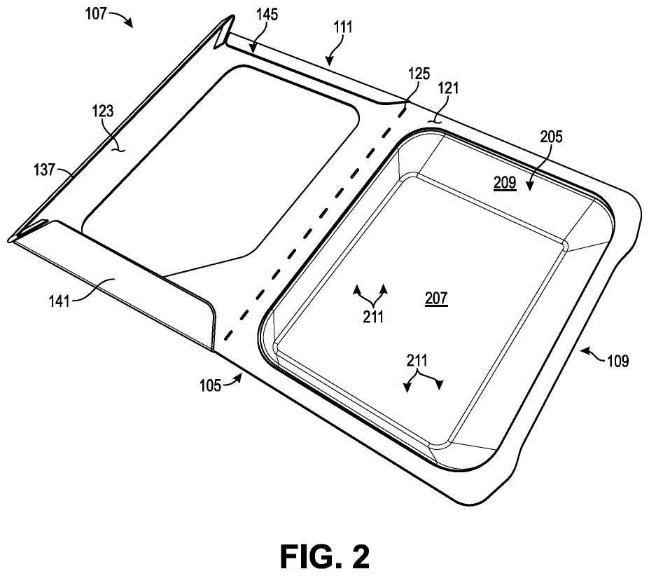

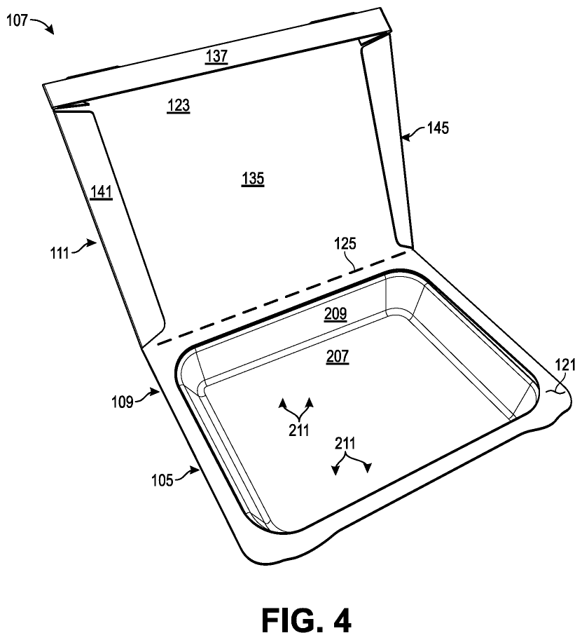

FIG. 1 illustrates an exterior surface 101 of blank 103 for forming a lid adapter 105 (shown in FIGS. 2-5) according to an embodiment of the disclosure. As described herein, the lid adapter 105 is for at least partially receiving a tray 205 to form a system 107 (shown in FIGS. 2-5). The lid adapter 105 can provide a hinged lid for the tray 205 in an openable and closeable/recloseable configuration, for example, to maintain one or more conditions of one or more food products held in the tray 205, to facilitate stacking/storage/transport, to allow for separate disposal of the lid adapter 105 and the tray 205, etc.

The blank 103 can have a longitudinal axis L1 and a lateral axis L2, as shown, though different reference axes could be used without departing from the disclosure. The blank 103 can include a plurality of panels that can include a base panel 121 and a lid panel 123 foldably connected to the base panel 121 at a lateral fold line 125.

The base panel 121, as shown, can have a generally rounded bracket-shaped outer free edge 127 that intersects the fold line 125, and which includes a lateral portion having a recessed portion 129 therealong that forms a pair of locking tabs 131 protruding longitudinally away from the remainder of the base panel 121 (e.g., protuberances).

The base panel 121 can at least partially define a base opening 133, as shown. The base opening 133 can be for at least engaging the tray 205 therethrough, as described further herein. While the base opening 133 is shown having a generally rounded rectangular configuration, it will be understood that the base opening 133 can be provided in a different arrangement without departing from the disclosure.

A lid opening 135 can also be formed in the lid panel 123, as shown, and can have a profile similar to that of the base opening 133, though the lid opening 135 may be smaller in area than the base opening 133. As described further herein, the lid opening 135 can be positioned in registration with the base opening 133 when the system 107/lid adapter 105 is provided in a closed configuration. Though the lid opening 135 is illustrated as having a chamfered edge, it will be understood that the lid opening 135 can be differently configured without departing from the disclosure.

A plurality of end flaps can be foldably connected to a respective panel of the plurality of panels of the blank 103 and lid adapter 105 formed therefrom, and can include a front end flap 137 foldably connected to the lid panel 123 at a lateral fold line 139, a first side end flap 141 foldably connected to the lid panel 123 at a longitudinal fold line 143, and a second side end flap 145 foldably connected to the lid panel 123 at a longitudinal fold line 147.

The first side end flap 141 can include a first base portion 149 and a first corner portion 151 foldably connected to the first base portion 149 at an oblique fold line 153. Similarly, the second side end flap 145 can include a second base portion 155 and a second corner portion 157 foldably connected to the second base portion 155 at an oblique fold line 159.

A first attachment end flap 161, as shown, can be foldably connected to the front end flap 137 at a longitudinal fold line 163, and a second attachment end flap 165 can be foldably connected to an opposite end of the front end flap 137 at a longitudinal fold line 167.

With continued reference to FIG. 1, a pair of locking cuts 171 can be provided interrupting the fold line 139 associated with the front end flap 137, and can be configured for at least partially receiving one or more respective locking tabs 131 protruding from the base panel 121 therethrough when the lid adapter 105 is formed from the blank 103 to at least partially maintain a closed configuration of the lid adapter 105. In this regard, the locking tabs 131 and locking cuts 171 can be locking features of the blank 103 and lid adapter 105.

As also shown, the blank 103 and lid adapter 105 formed therefrom can include or be provided with a film 173 at least partially extending across the lid opening 135. In some embodiments, the film 173 can be an at least partial barrier film that can, for example, at least partially inhibit the passage of one or more of moisture, heat, debris, pests, etc., between an exterior environment and a tray 205 associated with the lid adapter 105.

In this regard, the film 173 can be stretched or otherwise manipulated for generally planar registration with the lid panel 123 adjacent the lid opening 135. In some embodiments, such film 173 can be a polymeric and/or composite film such as cellophane. In some embodiments, the film 173 can be comprised of a transparent material to facilitate visualization of a tray 205 from an exterior environment. The film 173 can be adhered, for example, with an adhesive such as glue, around a periphery of the lid opening 135.

With additional reference to FIGS. 2-4, formation of the lid adapter 105 from the blank 103 and engagement with a tray 205 to form the system 107 will be described according to some embodiments of the disclosure.

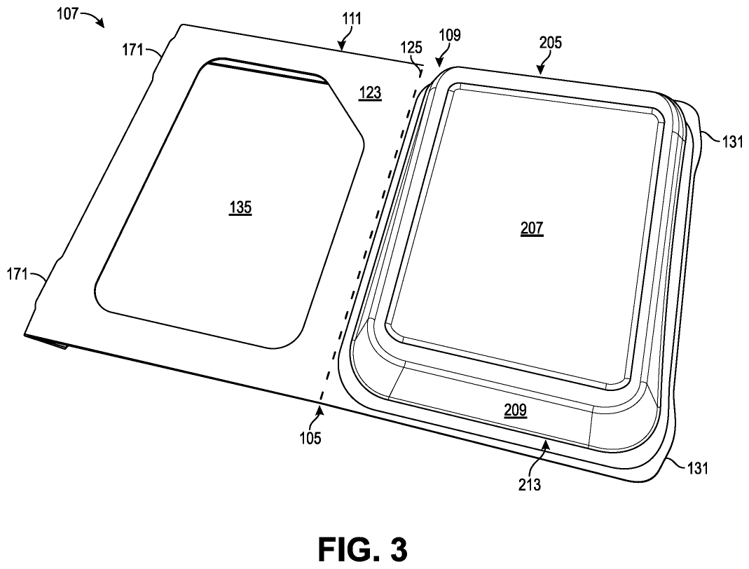

As shown in FIG. 2, the tray 205 can be of a form so as to have a bottom 207 and a sidewall 209 extending upwardly from the bottom 207 and at least partially around an interior 211 of the tray 205. A rim or flange 213, as shown in FIG. 3, can extend outwardly from the sidewall 209, e.g., away from the interior 211 of the tray 205, and can be positioned in generally spaced and planar parallel relation with the bottom 207.

The tray 205, in some embodiments, may be press formed from a blank into the aforementioned configuration. While the tray 205 is illustrated having a generally rounded rectangular profile, it will be understood that a different configuration 205 could be provided for use with the lid adapter 105 without departing from the disclosure. In some embodiments, a tray 205 could be formed from a plurality of components, for example, overlapping panels, end flaps, etc.

An interior surface of the base panel 121, e.g., a surface planarly opposite the exterior surface 101, can be positioned contacting the flange 213 of the tray 205 such that the base opening 133 generally circumscribes an opening into the interior 211 of the tray 205 at the flange 213.

The end flaps 137, 141, 145 can also be folded at the respective fold lines 139, 141, 147 so as to extend at least partially away from the lid panel 123. The first attachment end flap 161 can be at least partially folded at the fold line 163 into at least partial face-to-face contact with a portion of the first side end flap 141, and the second attachment end flap 165 can be at least partially folded at the fold line 167 into at least partial face-to-face contact with a portion of the second side end flap 145.

In some embodiments, the first corner portion 151 of the first side end flap 141 can be at least partially folded relative to the first base portion 149 thereof at the fold line 153, and/or the second corner portion 157 of the second side end flap 145 can be at least partially folded relative to the second base portion 155 thereof at the fold line 159, for example, to provide a collapsed or space-saving profile that can be conducive to storage, shipping, etc.

The aforementioned engagement of the base panel 121 with the tray 205 can form the system 107, such that the lid adapter 105 and the tray 205 are coupled to one another. In some embodiments, the base panel 121 can be adhered to the flange 213 of the tray 205 with one or more applications of an adhesive such as glue. In some embodiments, an adhesive such as glue can be applied to respective portions of the attachment end flaps 161, 165.

At least the base panel 121 can form a base 109 of the system 107, and at least the lid panel 123 can form a lid 111 of the system 107/lid adapter 105. In some embodiments, the tray 205 can form a portion of the base 109. In some embodiments, one or more of the end flaps 137, 141, 145, 161, 165 can form a portion of the lid 111.

An open or at least partially open configuration of the system 107/lid adapter 105 is illustrated in FIGS. 2-4, in which the lid 111 is at least partially lifted away from the base 109 so as to be in an open position.

In the open configuration of the system 107/lid adapter 105, the base opening 133 is uncovered by the lid 111 so as to facilitate access to the interior 211 of the tray 205 therethrough. In this regard, the lid 111 can be positioned in the open position to provide the open configuration of the system 107/lid adapter 105, for example, for loading of one or more food products in the interior 211 of the tray 205, to serve/inspect/maintain/display one or more food products in the interior 211 of the tray 205, etc.

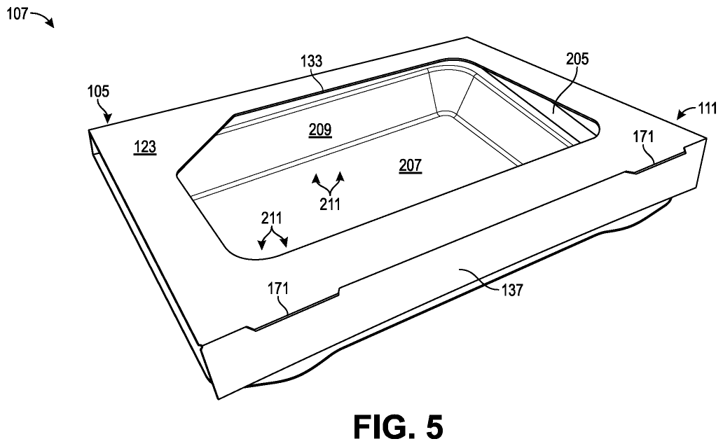

With additional reference to FIG. 5, the lid 111 can be at least partially folded at the fold line 125 into a closed position at least partially overlying the base opening 133 to provide a closed configuration of the system 107/lid adapter 105, for example, to inhibit access to one or more food products in the interior 211 of the tray 205, to store one or more food products in the interior 211 of the tray 205 prior to or following serving, to allow for stacking of multiple systems 107, etc.

It will be understood that the closed configuration of the system 107/lid adapter 105 can be at least partially maintained via the at least partial receipt of the respective locking tabs 131 through the respective locking cuts 171. When it is desired to unlock the system 107/lid adapter 105, the locking tabs 131 can be at least partially withdrawn through the respective locking cuts 171. The lid panel 123 may be repositionable multiple times between the open position and the closed position, allowing for repeated access to the interior 211 of the tray 205. The repositionable nature of the lid panel 123 provides flexibility for loading, serving, and storing food products while maintaining the structural integrity of the fold line 125 connection.

In the closed position, the lid 111 is positioned such that the lid opening 135 and the film 173 covering the lid opening 135 is in general registration with the base opening 133. In some embodiments, the lid panel 123 can be positioned in overlapping and/or at least partial face-to-face contact with the base panel 121.

In the closed configuration of the system 107, the lid 111 can be positioned such that the interior 211 of the tray 205 can be visualized through the lid opening 135 and the film 173 extending at least partially therealong. In this regard, in the closed configuration of the lid 111, the film 173 can provide a medium through which the contents of the tray 205 can be at least partially seen. Accordingly, the film 173 can be formed of an at least partially transparent material.

The aforementioned tray adapter 105 provides a tray, such as tray 205 or another tray, with a hinged lid configuration. Such an arrangement is advantageous in instances in which the trays 205 or other trays may be supplied from a separate source, e.g., in the case of press-formed trays that are not conducive to the inclusion of hingeable lid structures. Accordingly, forming methodologies for trays for use with the tray adapter 105 can be maintained while providing the advantages associated with a hinged lid.

Furthermore, the system 107 can be configured such that the lid adapter 105 and the tray 205 can be separated and disposed of separately, for example, to the extent that they can be designated in separate waste streams. For example, in the case that the lid adapter 105 is formed of renewable materials, such as paperboard, the lid adapter 105 can be designated for disposal in a recyclable or renewable waste stream, compost, etc., while the tray 205 can be designated for a different waste stream that may be incompatible with that of the lid adapter 105. Accordingly, commingling of materials that may be intended for different waste streams can be avoided.

It will be understood that one or more portions of the lid adapter 105 and/or the system 107 could be differently configured without departing from the disclosure.

Any of the features of the various embodiments of the disclosure can be combined with, replaced by, or otherwise configured with other features of other embodiments of the disclosure without departing from the scope of this disclosure. Further, it is noted that the nesting arrangements and/or the features of the blanks and cartons of the various embodiments can be incorporated into a container or blank having any container style or panel configuration. The container styles and panel configurations described above are included by way of example.

The blanks according to any of the embodiments of the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various embodiments. Various additions, modifications, changes, etc., could be made to the embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A lid adapter for a tray for holding one or more products, the lid adapter comprising:
a base panel having a base opening, the base panel arranged for attachment to a portion of the tray such that the base opening provides access to an interior of the tray; and
a lid panel foldably connected to the base panel, wherein the lid panel is repositionable between an open position and a closed position when the base panel is attached to the portion of the tray.

2. The lid adapter of claim 1, further comprising a front end flap foldably attached to the lid panel by a fold line, wherein the fold line is interrupted by a locking cut.

3. The lid adapter of claim 2, wherein the base panel includes at least one locking tab and wherein, when the lid panel is in the closed position the at least one locking tab is at least partially received through the locking cut.

4. The lid adapter of claim 3, wherein the at least one locking tab is at least partially defined by a recessed portion of a free edge of the base panel.

5. The lid adapter of claim 1, further comprising at least one side end flap foldably connected to the lid panel.

6. The lid adapter of claim 5, wherein the at least one side end flap includes a base portion and a corner portion foldably connected to the base portion.

7. The lid adapter of claim 1, further comprising a film at least partially extending across a lid opening.

8. A blank for forming a lid adapter for a tray for holding one or more products, the blank comprising:
a base panel having a base opening, the base panel arranged for attachment to a portion of the tray such that the base opening provides access to an interior of the tray; and
a lid panel foldably connected to the base panel, wherein the lid panel is repositionable between an open position and a closed position when the base panel is attached to the portion of the tray.

9. The blank of claim 8, further comprising a front end flap foldably attached to the lid panel by a fold line, wherein the fold line is interrupted by a locking cut.

10. The blank of claim 9, wherein the base panel includes at least one locking tab and wherein, when the lid panel is in the closed position the at least one locking tab is at least partially received through the locking cut.

11. The blank of claim 10, wherein the at least one locking tab is at least partially defined by a recessed portion of a free edge of the base panel.

12. The blank of claim 8, further comprising at least one side end flap foldably connected to the lid panel.

13. The blank of claim 12, wherein the at least one side end flap includes a base portion and a corner portion foldably connected to the base portion.

14. The blank of claim 8, further comprising a film at least partially extending across a lid opening.

15. A method for forming a lid adapter and attaching the lid adapter to a tray, the method comprising:
providing a blank including:
a base panel having a base opening; and
a lid panel foldably connected to the base panel, wherein the lid panel is repositionable between an open position and a closed position; and
attaching the base panel to a portion of the tray such that the base opening provides access to an interior of the tray.

16. The method of claim 15, the blank further comprises a front end flap foldably attached to the lid panel by a fold line, wherein the fold line is interrupted by a locking cut.

17. The method of claim 16, wherein the base panel includes at least one locking tab and wherein the method further comprises, wherein when the lid panel is in the closed position, at least partially receiving the at least one locking tab through the locking cut.

18. The method of claim 17, wherein the at least one locking tab is at least partially defined by a recessed portion of a free edge of the base panel.

19. The method of claim 15, wherein the blank further comprises at least one side end flap foldably connected to the lid panel.

20. The method of claim 19, wherein the at least one side end flap includes a base portion and a corner portion foldably connected to the base portion.

21. The method of claim 15, wherein the blank further comprises a film at least partially extending across a lid opening.

22. A system comprising:
a tray for holding one or more products; and
a lid adapter comprising:
a base panel having a base opening, the base panel attached to a portion of the tray
such that the base opening provides access to an interior of the tray; and
a lid panel foldably connected to the base panel, wherein the lid panel is repositionable between an open position and a closed
position when the base panel is attached to the portion of the tray.

23. The system of claim 22, wherein the lid adapter further comprises a front end flap foldably attached to the lid panel by a fold line, wherein the fold line is interrupted by a locking cut.

24. The system of claim 23, wherein the base panel includes at least one locking tab and wherein, when the lid panel is in the closed position the at least one locking tab is at least partially received through the locking cut.

25. The system of claim 24, wherein the at least one locking tab is at least partially defined by a recessed portion of a free edge of the base panel.

26. The system of claim 22, wherein the lid adapter further comprises at least one side end flap foldably connected to the lid panel.

27. The system of claim 26, wherein the at least one side end flap includes a base portion and a corner portion foldably connected to the base portion.

28. The system of claim 22, wherein the lid adapter further comprises a film at least partially extending across a lid opening.
